(19) United States
(12) Patent Application Publication
(10) Pub. No.: US 2013/0185155 A1
(43) Pub. Date: Jul. 18, 2013

(54) SYSTEMS AND METHODS FOR PROVIDING CONTRIBUTIONS FROM THIRD PARTIES TO LOWER A COST OF A TRANSACTION FOR A PURCHASER

(71) Applicant: Big Red Pen, Inc., Seattle, WA (US)

(72) Inventor: Marc D. Colando, Seattle, WA (US)

(73) Assignee: Big Red Pen, Inc., Seattle, WA (US)

(21) Appl. No.: 13/739,984

(22) Filed: Jan. 11, 2013

Related U.S. Application Data
(60) Provisional application No. 61/586,067, filed on Jan. 12, 2012.

(51) Int. Cl. G06Q 30/02

(52) U.S. Cl. CPC G06Q 30/0256
USPC 705/14.54; 705/26.1

(57) ABSTRACT

Systems and methods of enabling cross-promotion of products and services during a purchase transaction are provided. An offer management system provides contribution offers to a purchaser in response to a request for discounts for a product. Upon acceptance of the offers by the purchaser, the offer management system causes funds to be transferred from one or more contributor payment accounts to a retail point-of-sale system. These funds are combined with funds from the purchaser to provide the full price to the retailer for the product. The offer management system monitors purchaser activity to determine if the purchaser later complies with conditions of the offers. In some embodiments, the offer management system may be used by traditional point-of-sale systems without requiring special configuration to work with the offer management system.

### CROSS-REFERENCE TO RELATED APPLICATION

This application claims the benefit of Provisional Application No. 61/586,067, filed Jan. 12, 2012, the entire disclosure of which is hereby incorporated by reference herein.

### BACKGROUND

Mobile devices and internet marketing have greatly expanded the number of marketing channels available. However, cross-promotion of products and/or services during retail transactions often requires individual negotiation of cross-promotional deals. Outside systems that provide cross-promotional discounts may require that the retailer initially cover the cost of the discount before being reimbursed by a third party. The cost and risk of receiving less than retail price for products may cause many retailers to be unwilling to offer discounts based on contributions from third parties for cross-promotion.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, an offer management system is provided. The offer management system comprises one or more computing devices that are configured to provide a transaction processing engine. The transaction processing engine is configured to query an offer data store for a set of offers based on an offer search request associated with a product and a purchaser; receive, from the purchaser, a choice of one or more offers from the set of offers; and for each chosen offer, cause an amount of funds indicated by the chosen offer to be transferred to a purchase fulfillment account.

In some embodiments, a computer-implemented method of configuring a computing device to interact with a server is provided. The method comprises receiving, by a computing device, contact information associated with a purchaser; modifying, by the computing device, the contact information to include a relationship referencing contact information associated with the server; and transmitting the modified contact information to a purchaser computing device.

In some embodiments, a computer-implemented method of communicating with a server using a computing device is provided. The method comprises storing, by the computing device in a contact data store, server contact information associated with the server; transmitting, by the computing device, purchaser contact information associated with a purchaser to the server; receiving, by the computing device, modified purchaser contact information; and storing, by the computing device, the modified purchaser contact information in the contact data store.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating, at a high level, a flow of funds in a transaction as enabled by various aspects of the present disclosure;

FIG. 2 is a block diagram that illustrates one embodiment of an offer management system according to various aspects of the present disclosure;

FIG. 3 illustrates an exemplary hardware architecture of a computing device suitable for use with embodiments of the present disclosure;

FIG. 4 is a conceptual diagram illustrating, at a high level, an exemplary embodiment of submitting a request to an offer management system according to various aspects of the present disclosure;

FIG. 5 is a flowchart that illustrates one embodiment of a method of configuring a purchaser computing device to submit offer queries using a natural user interface provided by the purchaser computing device;

FIGS. 6A-6B are a flowchart that illustrates one embodiment of a method of using offers in a purchase transaction according to various aspects of the present disclosure; and

FIGS. 7A-7D are interface drawings that illustrate an exemplary embodiment of an interface presented by the interface presentation engine according to various aspects of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In some embodiments of the present disclosure, systems and methods of enabling cross-promotion of products and services during a purchase transaction are provided. A centralized offer management system enables such offers to be made and fulfilled without requiring individual negotiation of cross-promotional campaigns. Further, in some embodiments, the offer management system may be used by traditional point-of-sale systems without requiring special configuration to work with the offer management system.

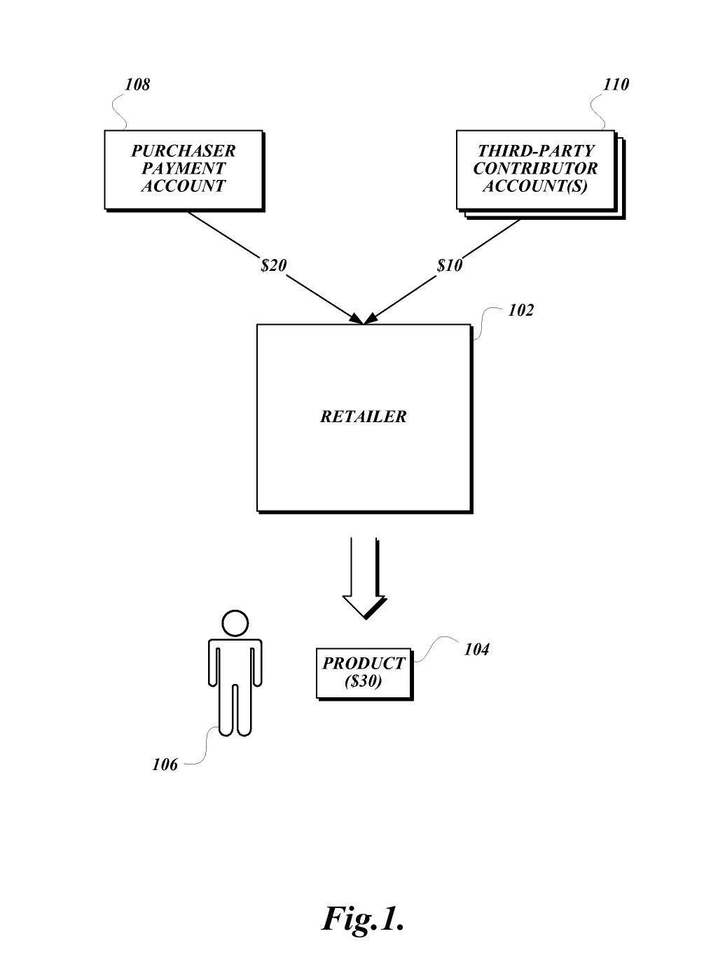

FIG. 1 is a block diagram illustrating, at a high level, a flow of funds in a transaction as enabled by various aspects of the present disclosure. A purchaser 106 finds a product 104 offered for sale by a retailer 102, and decides that he would like to purchase the product 104. The product 104 may have an associated cost, for example, $30. However, the purchaser 106 may only be willing to pay $20 for the product 104. One of ordinary skill in the art will recognize that these prices are merely used for discussion and that other prices and/or types of payment may be used in other embodiments.

Traditionally, this disconnect between a price the purchaser 106 is willing to pay and the price set by the retailer 102 may lead to the purchaser 106 deciding to delay or avoid purchase of the product 104, to look for the product 104 at a better price at a different retailer, and/or the like. Any of these decisions may lead to a lost sale for the retailer 102. Though in rare occasions the purchaser 106 may be able to haggle with the retailer 102 in an attempt to get the retailer 102 to reduce the price of the product 104, cultural taboos, retailer policy, and/or the like may eliminate this as a possibility in most cases.

According to various aspects of the present disclosure, a system (not illustrated in FIG. 1, but illustrated and described further below) may receive an indication from the purchaser 106 that he is only willing to pay the retailer 102 $20 for the $30 product 104. The system may search for offers from one or more third-party contributors that may be associated with a sale of the product 104 by the retailer 102. The offers may each indicate a contribution a third-party contributor is willing to make toward the price of the product 104 in exchange for an action taken by the purchaser 106. If the offers are acceptable to the purchaser 106, the amount the purchaser 106 was willing to pay is transmitted to the retailer 102 from a purchaser payment account 108, and the offer contribution amounts are transmitted to the retailer 102 from one or more third-party contributor accounts 110.

In some embodiments, offers may include something of value to the purchaser 106 other than a contribution to the purchase price of the product 104. For example, an offer may include points in a loyalty program, priority access to a product with limited availability, reduced-cost shipping or other post-purchase processing, and/or the like. Though offers that involve a contribution to the purchase price of a product 104 are discussed primarily herein, one of ordinary skill in the art will recognize that these offers are referred to for ease of discussion only, and that offers that provide other value to the purchaser 106 may be used without departing from the scope of the present disclosure.

Many advantages may be obtained by providing such transactions. As a nonlimiting example, the retailer 102 receives the full retail price for the product 104 at the time of sale, and does not have to apply for reimbursement from the offer contributors 232, thus lowering the cost of participation in the system for the retailer 102. As another nonlimiting example, the retailer 102 may be able to consummate a sale of the product 104 to the purchaser 106 in situations where the purchaser 106 may have otherwise decided against the purchase due to price. As yet another nonlimiting example, the system may provide the third-party contributors with a new, highly directed marketing channel, and may help the third party contributors more effectively build networks of potential customers on social media, as discussed further below. Third-party contributors such as a credit card company may offer contributions for using their credit card, thus encouraging use of the card. Offers associated with the purchase of an additional product may be used to drive sales of the particular product. One of ordinary skill in the art will recognize that other advantages may also be obtained using various embodiments of the present disclosure.

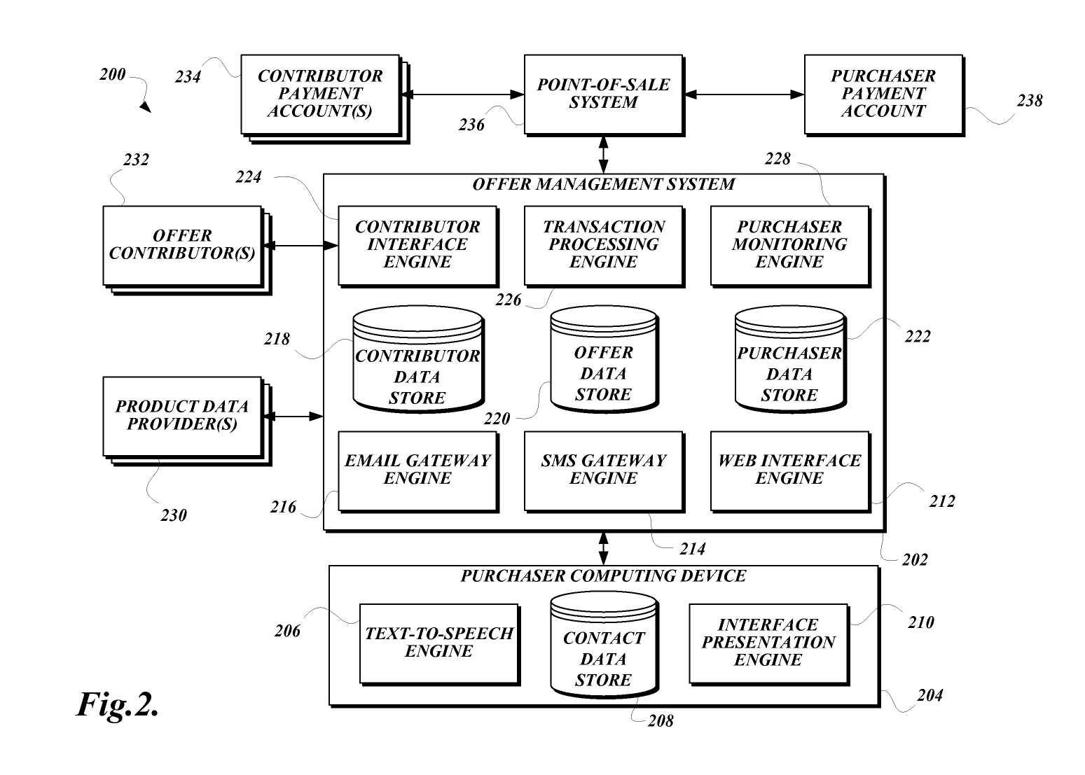

FIG. 2 is a block diagram that illustrates one embodiment of an offer management system according to various aspects of the present disclosure. The offer management system 202 stores offers from one or more offer contributors 232. The offer management system 202 may present one or more offers to a purchaser 106 via a purchaser computing device 104 in association with a purchase of a product 104 from a retailer 102. Once a set of offers is selected, the offer management system 202 causes contributions indicated by the set of offers to be transferred from one or more contributor payment accounts 234 to a point-of-sale system 236 operated by the retailer 102. A remainder of funds associated with the purchase transaction is provided to the point-of-sale system 236 from a purchaser payment account 238 associated with the purchaser 106 in order to complete the transaction.

In some embodiments, the point-of-sale system 236 may be any type of system used by any type of retailer 102 to process sales transactions. In some embodiments, the point-of-sale system 236 may be a cash register at a brick-and-mortar retailer, configured to accept cash payments, credit card payments, debit card payments, and/or the like. In some embodiments, the point-of-sale system 236 may be a system operated by an internet-based retailer, wherein the point-of-sale system 236 accepts payment information from the purchaser 106 via the internet. In some embodiments, the point-of-sale system 236 may include components specially configured to integrate with the offer management system 202. In some embodiments, the point-of-sale system 236 may not be specially configured to operate with the offer management system 202, but may instead receive funds from one or more contributor payment accounts 234 as well as a purchaser payment account 238 via a traditional split tender transaction.

In some embodiments, the contributor payment accounts 234 may be traditional bank accounts established by the offer contributors 232, accessible via a debit card, credit card, wire transfer, routing transit number/account number, and/or the like. The offer contributor 232 may load the contributor payment account 234 with a predetermined amount of funds, and may provide offers until the funds are fully depleted. In some embodiments, a contributor payment account 234 may be associated with one or more one-time use credit card number, such as a controlled payment number, a virtual credit card number, and/or the like. A new one-time use number for the contributor payment account 234 may be issued each time an offer is accepted. In some embodiments, a contributor payment account 234 may be a ledger account, wherein actual funds are transferred from an account controlled by the offer management system 202 instead of the offer contributor 232. In such an embodiment, the offer management system 202 may periodically submit invoices to the offer contributor 232 to reimburse the offer management system 202 for the contributed funds.

In some embodiments, the purchaser payment account 238 may be any type of payment account usable by a purchaser 106 during a retail purchase transaction. In some embodiments, the purchaser payment account 238 may be a credit card account, a checking account, a debit card account, and/or the like. In some embodiments, payments from the purchaser payment account 238 may be made using cash, a check, or any other suitable payment method.

In some embodiments, the purchaser computing device 204 may be any computing device suitable for connecting to the offer management system 202 and enabling the purchaser 106 to request and accept offers associated with a purchase transaction. In one exemplary embodiment, the purchaser computing device 204 may be a desktop computer, and the offers may be requested and displayed on or in association with a product information web page at a web-based retailer. In another exemplary embodiment, the purchaser computing device 204 may be a smart phone, and the offers may be requested and displayed by a custom application configured to programmatically communicate with the offer management system 202 to request and display offers. One of ordinary skill in the art will appreciate that other types of computing devices may be used as a purchaser computing device 204.

In some embodiments, the purchaser computing device 204 includes a text-to-speech engine 206, a contact data store 208, and an interface presentation engine 210. The interface presentation engine 210 may be any suitable presentation framework for presenting offers to the purchaser 106 and for receiving a selection of presented offers from the purchaser 106. In some embodiments, the interface presentation engine 210 may include a traditional web browser, and may present a web interface generated by the offer management system 202. In some embodiments, the interface presentation engine 210 may include a stand-alone application that programmatically communicates with the offer management system 202 via one or more application programming interfaces (APIs) to obtain offer information and to transmit selections of offers.

In some embodiments, the contact data store 208 may include contact information for a plurality of individuals, including contact information for the offer management system 202. The contact information for the offer management system 202 may include, but is not limited to, a phone number associated with an SMS gateway, an email address, a URL, and/or the like. The contact data store 208 may include contact information for the purchaser 106, and such information may include relationship information that indicates relationships between the purchaser 106 and other contacts stored in the contact data store 208. For example, a “spouse” relationship established between the contact information of the purchaser 106 and contact information of a second individual would indicate that the second individual is the spouse of the purchaser 106.

In some embodiments, the purchaser 106 may use the contact information of the offer management system 202 stored in the contact data store 208 to submit requests for offers associated with a product 104. In some embodiments, the request may be submitted by the purchaser 106 via the purchaser computing device 204 using the text-to-speech engine 206, though in some embodiments, any suitable input method made available by the purchaser computing device 204 may be used to receive the request. For example, a product bar code, a picture of the product, and/or the like may be captured with a camera of the purchaser computing device 204 and included with the request to identify the product 104. As another example, an identification of the product 104 may be manually entered by the purchaser 106 into the purchaser computing device 204, or may be selected by the purchaser 106 from a set of products presented by the purchaser computing device 204. Once a set of offers is obtained from the offer management system 202, the offers may be presented by the interface presentation engine 210.

In some embodiments, the offer management system 202 may include an email gateway engine 216, an SMS gateway engine 214, and/or a web interface engine 212.

These engines may provide a variety of communication paths for a purchaser computing device 204 to interact with the offer management system 202. The email gateway engine 216 may be configured accept email from the purchaser computing device 204, parse or otherwise extract content from the email, and route the extracted content to other components of the offer management system 202 for further processing. The email gateway engine 216 may also be configured to compose and send emails to an email account associated with the purchaser 106 based on information provided by other components of the offer management system 202. The SMS gateway engine 214 may include similar functionality to the email gateway engine 216, but may operate using SMS text messaging instead of email. In some embodiments, the web interface engine 212 may generate a web-based user interface to be transmitted to the purchaser computing device 204 and presented by the interface presentation engine 210. In some embodiments, the web interface engine 212 may provide a web service that may be programmatically accessed by the interface presentation engine 210 to obtain data from the offer management system 202. In some embodiments, one or more of the email gateway engine 216, SMS gateway engine 214, and/or web interface engine 212 may be provided by a party separate from the offer management system 202, and may be programmatically connected to other components of the offer management system 202 via one or more communication networks.

In some embodiments, the offer management system 202 includes a contributor interface engine 224. In some embodiments, the contributor interface engine 224 may generate a web-based interface that enables one or more offer contributors 232 to interact with various components of the offer management system 202. The interface generated by the contributor interface engine 224 may enable an offer contributor 232 to create new offers, or to manage existing offers. The contributor interface engine 224 may enable the offer contributor 232 to specify various configuration details for an offer. As some nonlimiting examples of configuration details, an offer contributor 232 may be able to specify types of users to whom the offer should be provided, offer start and/or end dates, products or product types with which the offer should or should not be associated, retailers with which the offer should or should not be associated, and/or the like. An offer contributor 232 may also be able to specify a total amount of offers available. For example, an offer contributor 232 may establish a pool of a predetermined amount of funds, and that the offer should be active until the predetermined amount of funds has been exhausted.

In some embodiments, the contributor interface engine 224 may present an interface to an offer contributor 232 that allows the offer contributor 232 to create one or more new offers by filling in one or more blanks. For example, the contributor interface engine 224 may present a complete offer as a textual description, and may provide blanks for aspects of the offer configurable by the offer contributor 232. Further, each blank may be associated with a prompt indicating one or more valid entries for the blank, or may be associated with one or more discrete values to be chosen by the offer contributor 232 to fill the blank.

In some embodiments, the contributor interface engine 224 (or some other component of the offer management system 202) may provide an interface for retailers 102 or product manufacturers to control the types of offers that may be associated with their transactions or products. For example, a first retailer may exclude offers from a second, rival retailer. As another nonlimiting example, the first retailer may have an exclusive marketing arrangement with a particular brand of soda pop, and therefore may opt out of being associated with offers for any other brand of soda pop.

In some embodiments, an opt-out model may make it particularly convenient for offer contributors 232 to obtain access to marketing channels that would previously have been unavailable to them. For example, a small company that makes mobile phone cases for a popular mobile phone may not have the staff or budget to negotiate cross-promotion deals with big-box retailers who sell the mobile phone. However, that small company may be able to act as an offer contributor 232 within the offer management system 202, and thereby have offers associated with their mobile phone cases be presented when the popular mobile phone is being purchased. The small company would have access to this transaction without negotiating with the large retailers, or with the manufacturer of the mobile phone. Unless the retailer or manufacturer explicitly opts out of having the small company's offers associated with their transactions, the small company will newly have access to this highly directed marketing channel.

In some embodiments, the offer management system 202 may include a purchaser monitoring engine 228. The purchaser monitoring engine 228 may be configured to interact with one or more external data sources to determine whether a purchaser has complied with actions associated with an accepted offer. For example, an offer from an offer contributor 232 may require that the purchaser connect to the offer contributor 232 on a social media platform, such as creating a “like” on Facebook, “following” a Twitter feed, and/or the like. The purchaser monitoring engine 228 may be configured to check the social media platform to determine whether the purchaser has taken the specified action. As another example, an offer from an offer contributor 232 may require that the purchaser use a particular form of payment, such as a credit card offered by the offer contributor 232 and/or the like, either in the present transaction or in one or more related transactions. As yet another example, an offer from an offer contributor 232 may require that the purchaser purchase an additional product other than the product 104 currently being contemplated for purchase. In some embodiments, the offer management system 202 may allow the funds to be transferred to fulfill the purchase associated with the offer before such verification has been completed, and may check back periodically to determine whether the purchaser has completed the task.

In some embodiments, the offer management system 202 may include a transaction processing engine 226. The transaction processing engine 226 may perform one or more actions relating to finding offers related to a transaction in response to receiving a request from a purchaser computing device 204, receiving selections of offers from the purchaser computing device 204, transferring funds to and from contributor payment accounts 234, and/or the like. Actions performed by some embodiments of the transaction processing engine 226 are discussed in further detail below.

In general, the word “engine” (used interchangeably with the word application or module), as used herein, refers to logic embodied in hardware or software instructions, which may be written in a programming language, such as C, C++, COBOL, JAVA™, PHP, Perl, HTML, CSS, JavaScript, VBScript, ASPX, Microsoft .NET™, and/or the like. An engine may be compiled into executable programs or written in interpreted programming languages. Software engines or applications may be callable from other engines or from themselves. Generally, the engines or applications described herein refer to logical modules that can be merged with other engines or applications, or can be divided into sub-engines. The engines or applications may be stored in any type of computer-readable medium or computer storage device and be stored on and executed by one or more general purpose computers, thus creating a special purpose computer configured to provide the engine or application.

In some embodiments, the offer management system 202 may include a contributor data store 218, an offer data store 220, and/or a purchaser data store 222. The contributor data store 218 may include information identifying one or more offer contributors 232, including login information, name information, and/or the like. In some embodiments, the contributor data store 218 may include information associated with one or more contributor payment accounts 234, including balance information, information associating each offer contributor 232 with one or more contributor payment accounts 234, account access information to allow the offer management system 202 to transfer funds into and out of the contributor payment accounts 234, and/or the like. In some embodiments, the offer data store 220 stores information associated with one or more offers submitted by offer contributors 232 and made available for presentation to purchasers 106. Details of the information associated with offers are described elsewhere herein. In some embodiments, the purchaser data store 222 includes information associated with one or more purchasers 106. As nonlimiting examples, the purchaser data store 222 may include a purchaser name, purchaser login information, purchaser contact information, information identifying a purchaser computing device 204 associated with the purchaser 106, information identifying a purchaser payment account 238, and/or the like. In some embodiments, the purchaser data store 222 may store a record of offers accepted by each purchaser, along with records generated by the purchaser monitoring engine 228 regarding whether the purchaser has performed actions associated with acceptance of the offer.

As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network or provided as a cloud-based service. A data store may also include data stored in an organized manner on a storage medium 308, as described further below. One of ordinary skill in the art will recognize that separate data stores described herein may be combined into a single data store, and/or a single data store described herein may be separated into multiple data stores, without departing from the scope of the present disclosure.

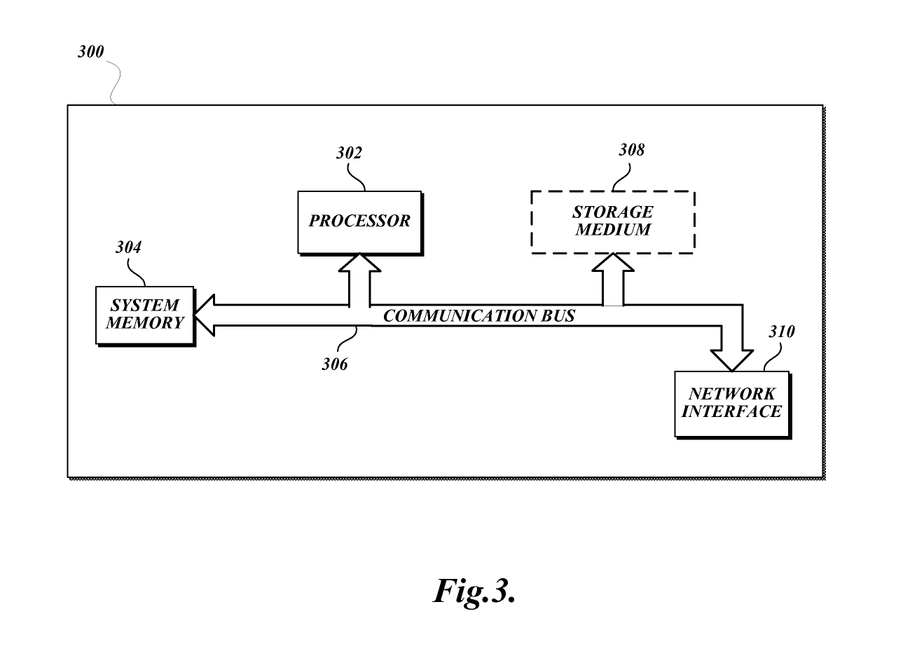

FIG. 3 illustrates an exemplary hardware architecture of a computing device 300 suitable for use with embodiments of the present disclosure. Those of ordinary skill in the art and others will recognize that the computing device 300 may be any one of any number of currently available or yet to be developed devices. In its most basic configuration, the computing device 300 includes at least one processor 302 and a system memory 304 connected by a communication bus 306. Depending on the exact configuration and type of device, the system memory 304 may be volatile or nonvolatile memory, such as read only memory (“ROM”), random access memory (“RAM”), EEPROM, flash memory, or similar memory technology. Those of ordinary skill in the art and others will recognize that system memory 304 typically stores data and/or program modules that are immediately accessible to and/or currently being operated on by the processor 302. In this regard, the processor 302 serves as a computational center of the computing device 300 by supporting the execution of instructions.

As further illustrated in FIG. 3, the computing device 300 may include a network interface 310 comprising one or more components for communicating with other devices over a network. Embodiments of the present disclosure may access basic services that utilize the network interface 310 to perform communications using common network protocols, such as TCP/IP, UDP, USB, Firewire, and/or the like.

In the exemplary embodiment depicted in FIG. 3, the computing device 300 also includes a storage medium 308. However, services may be accessed using a computing device that does not include means for persisting data to a local storage medium. Therefore, the storage medium 308 depicted in FIG. 3 is represented with a dashed line to indicate that the storage medium 308 is optional. In any event, the storage medium 308 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and the like.

As used herein, the term “computer-readable media” includes volatile and nonvolatile and removable and nonremovable media implemented in any method or technology capable of storing information, such as computer-readable instructions, data structures, program modules, or other data. In this regard, the system memory 304 and storage medium 308 depicted in FIG. 3 are merely examples of computer-readable media.

Suitable implementations of computing devices that include a processor 302, system memory 304, communication bus 306, storage medium 308, and network interface 310, such as desktop computers, server computers, tablet computers, smart phones, mobile devices, PDAs, and/or the like, are known and commercially available. For ease of illustration and because it is not important for an understanding of the claimed subject matter, FIG. 3 does not show some of the typical components of many computing devices. In this regard, the computing device 300 may include one or more input devices. Similarly, the computing device 300 may also include one or more output devices.

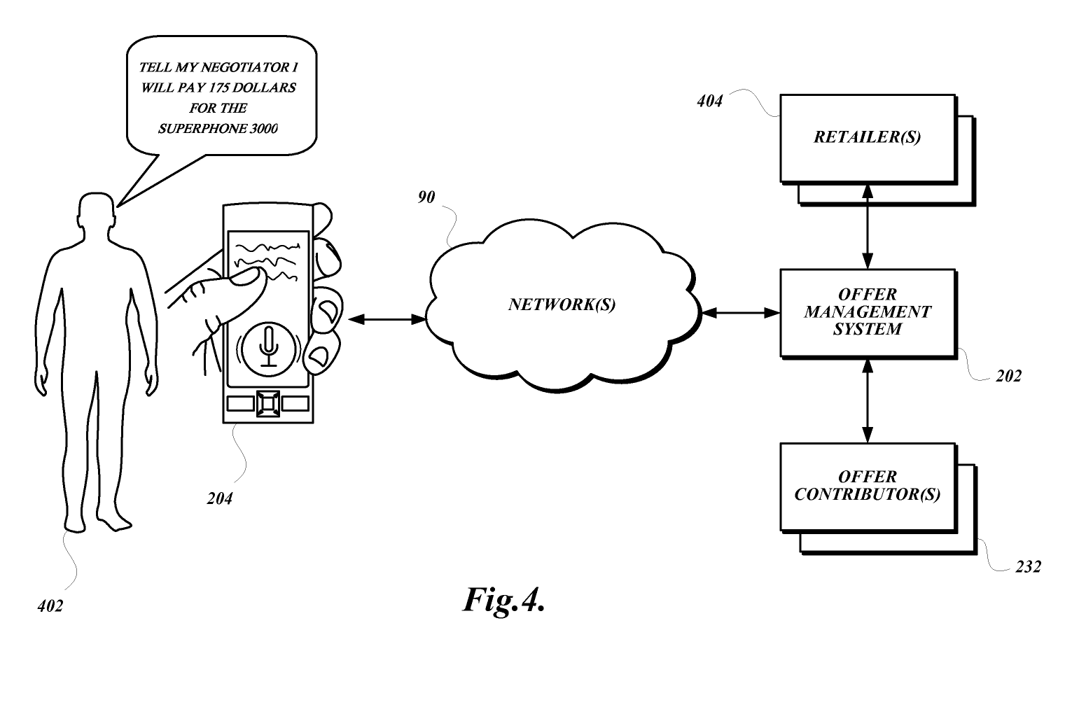

While a purchaser computing device 204 could connect directly to a web interface engine 212 to interact with the offer management system 202, current purchaser computing devices 204 such as smart phones and/or the like provide convenient natural user interfaces such as text-to-speech engines 206 that can simplify interactions with the offer management system 202. FIG. 4 is a conceptual diagram that illustrates, at a high level, an exemplary embodiment of submitting a request to an offer management system 202 via a natural user interface, according to various aspects of the present disclosure. This method of submitting requests to the offer management system 202 is exemplary only, and any suitable method of transmitting requests to the offer management system 202 via any suitable computing device may instead be used. In the illustrated embodiment, a purchaser 402 uses a text-to-speech engine 206 of a purchaser computing device 204 to submit a request for offers to an offer management system 202 via one or more networks 90. As illustrated, the purchaser computing device 204 may be a mobile phone, but in other embodiments, the purchaser computing device 204 may be any other suitable type of computing device. The purchaser computing device 204 may analyze the spoken query stated by the purchaser 402 to identify that the spoken query is intended for the offer management system 202, and may then transmit an analyzed version of the query to the offer management system 202 for further processing. The offer management system 202 may identify one or more retailers 404 at which the requested product is available, and/or may identify one or more offers or offer contributors 232 that may be used to provide value to the purchaser 402 during a purchase from a retailer 404.

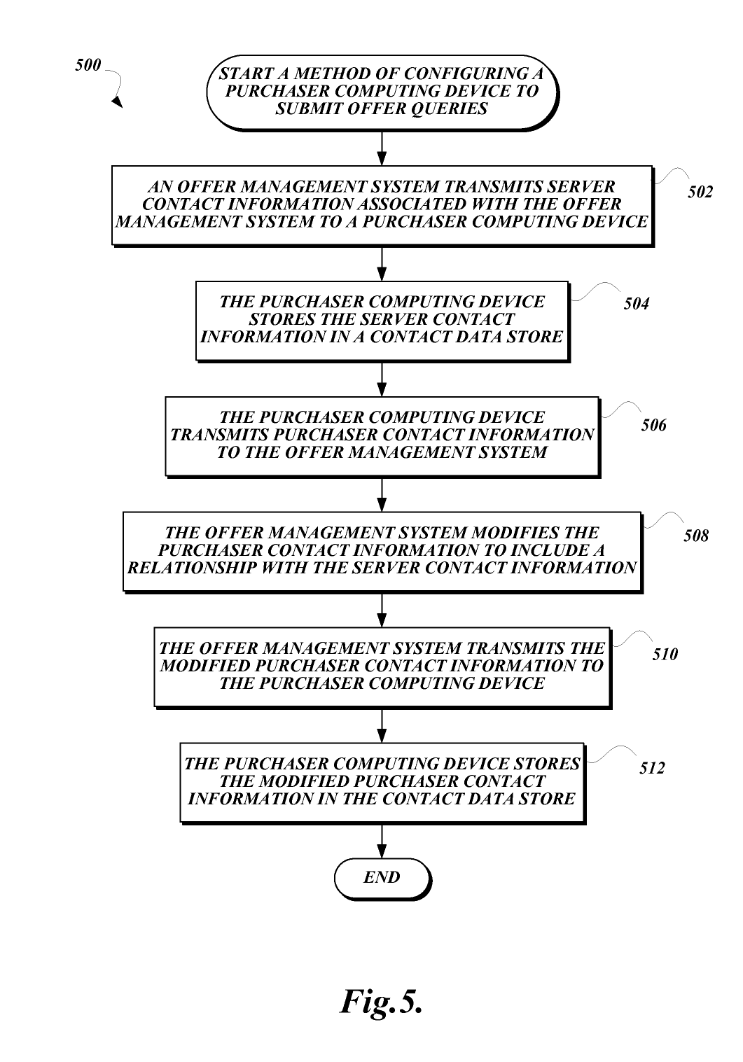

FIG. 5 is a flowchart that illustrates one embodiment of a method 500 of configuring a purchaser computing device 204 to submit offer queries using a natural user interface provided by the purchaser computing device 204.

From a start block, the method 500 proceeds to block 502, where an offer management system 202 transmits server contact information associated with the offer management system 202 to a purchaser computing device 204. In some embodiments, the server contact information may be stored within a vCard, and may include a name, a mailing address, an email address, a telephone number, an SMS number, a URL, and/or other contact information associated with contacting the offer management system 202. Next, at block 504, the purchaser computing device 204 stores the server contact information in a contact data store 208. In some embodiments, the purchaser computing device 204 may be configured to create a new contact in the contact data store 208 based on the received vCard.

In some embodiments, the purchaser computing device 204 may store contact information associated with the purchaser 106 in the contact data store 208 as a contact or vCard in order to provide other functionality related to contacting the purchaser 106, such as exchanging business cards with other devices and/or the like. In some embodiments, the contact information includes relationship information identifying relationships with other contacts stored in the contact data store 208. The storing of the purchaser contact information and relationship information by the purchaser computing device 204 may allow natural language processing on the purchaser computing device 204 to understand the meaning of phrases including first-person possessive pronouns, such as “my wife,” “my brother,” and/or the like. At block 506, the purchaser computing device 204 transmits the purchaser contact information to the offer management system 202. In some embodiments, this may be sent as a vCard, and may include the relationship information. In some embodiments, the purchaser computing device 204 may transmit the purchaser contact information as a vCard attachment to an email sent to the email gateway engine 216.

At block 508, the offer management system 202 modifies the purchaser contact information to include a relationship with the server contact information. For example, in some embodiments, the offer management system 202 may add a “negotiator” relationship to the purchaser contact information that refers to the contact information of the offer management system 202. This would allow natural language processing on the purchaser computing device 204 to understand that the phrase “my negotiator” refers to the offer management system 202. In other embodiments, different or additional names could be applied to the relationship without departing from the scope of the present disclosure. The method 500 proceeds to block 510, where the offer management system 202 transmits the modified purchaser contact information to the purchaser computing device 204.

Next, at block 512, the purchaser computing device 204 stores the modified purchaser contact information in the contact data store 208, thus establishing the relationship between the purchaser's contact information and the contact information of the offer management system 202 in the contact data store 208. The method 500 then proceeds to an end block and terminates.

Once the method 500 has been performed, the purchaser computing device 204 may be used in a simple way to obtain offers from the offer management system 202. For example, the text-to-speech engine 206 may receive a spoken statement such as, “Tell my negotiator that I want to pay $30 for a SuperPhone 3000 at the Super Phone Co. Store.” The text-to-speech engine 206 may convert the spoken phrase to text, and understands that “my negotiator” refers to the contact information of the offer management system 202. The purchaser computing device 204 may then transmit the remainder of the phrase to the offer management system 202 for processing with little to no further input from the purchaser 106.

The above description of contacting the offer management system 202 to obtain offers is exemplary only, and in some embodiments, other simplified ways of contacting the offer management system 202 may be used. For example, similar request text may be input via a keyboard instead of via voice input. As another example, portions of the request may be retrieved via multimedia, such as identifying a product by taking a picture, scanning a bar code, and/or the like.

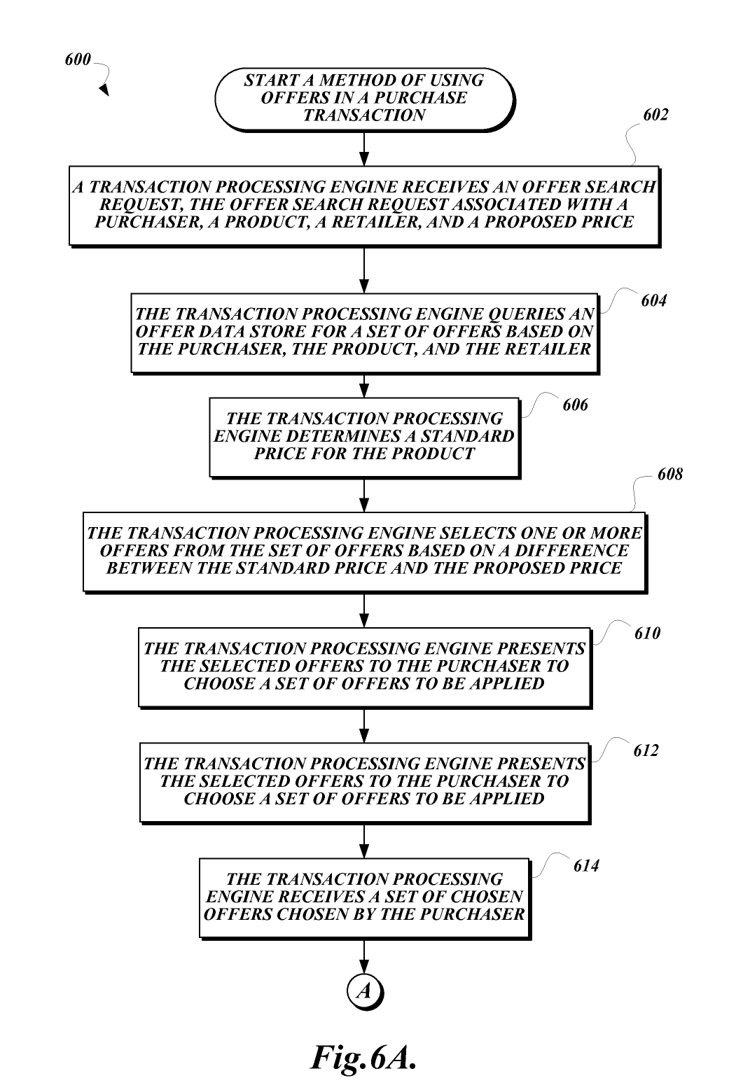

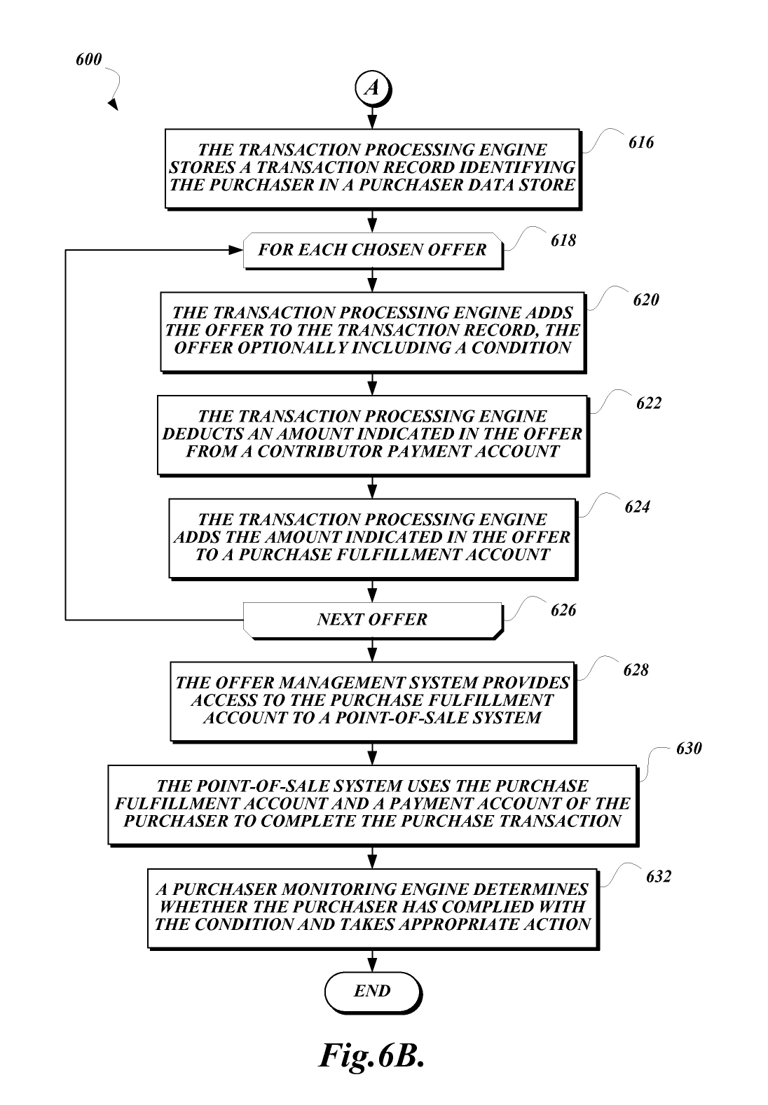

FIGS. 6A-6B are a flowchart that illustrates one embodiment of a method 600 of using offers in a purchase transaction according to various aspects of the present disclosure. From a start block, the method 600 proceeds to block 602, where a transaction processing engine 226 receives an offer search request, the offer search request associated with a purchaser 106, a product 104, a retailer 102, and a proposed price. In some embodiments, the offer search request may be received from a purchaser computing device 204. In some embodiments, some of the elements of the offer search request, such as the proposed price, may be optional. The identification of the product 104 may be obtained by manual entry of a model name or number, by scanning a bar code of the product 104, by taking a picture of the product 104, and/or by any other suitable method. The retailer 102 may be identified by manual entry, by location information obtained from the purchaser computing device 204 while the purchaser 106 is at a brick-and-mortar retail location, and/or by any other suitable method.

At block 604, the transaction processing engine 226 queries an offer data store 220 for a set of offers based on the purchaser 106, the product 104, and the retailer 102. The transaction processing engine 226 may query based on exclusions associated with the retailer 102 or product 104; demographic information, brand affinity, purchase history associated with the purchaser 106, time-based retailer inventories, coupons, and/or the like.

The method 600 proceeds to block 606, where the transaction processing engine 226 determines a standard price for the product 104. In some embodiments, the transaction processing engine 226 may obtain the standard price from a product data provider 230 operated by a third party, such as the manufacturer of the product 104, the retailer 102, a publicly accessible web-based product information repository, and/or the like. In some embodiments, the standard price for the product 104 may be an advertised retail price included with the offer search request.

Next, at block 608, the transaction processing engine 226 selects one or more offers from the set of offers based on a difference between the standard price and the proposed price. In some embodiments, the transaction processing engine 226 may attempt to select a combination of offers from the set of offers that will provide enough of a discount to provide the purchaser 106 with their proposed price. If not enough offers are available to provide an adequate discount, the transaction processing engine 226 may select all of the offers from the set of offers to get as close to the proposed price as possible, or may instead return a failure message. In some embodiments, if a proposed price was not provided, the transaction processing engine 226 may select offers from the set of offers using a predetermined total discount as a target total discount. If more offers are available than are needed to meet the proposed price, the transaction processing engine 226 may choose offers from the set of offers based on a computed likelihood of acceptance, a subscription level of the offer contributor 232, an amount of time remaining before offer expiration, a preference of the retailer 102, and/or any other suitable information. The transaction processing engine 226 may select more offers than necessary to obtain the proposed price, and the difference between the total offer contributions and the desired discount may be returned to the offer contributors 232 or be retained by the offer management system 202.

At block 610, the transaction processing engine 226 presents the selected offers to the purchaser 106 to choose a set of offers to be applied. In some embodiments, the transaction processing engine 226 transmits the selected offers to the purchaser 106 computing device 204 via the web interface engine 202, and the interface presentation engine 210 of the purchaser computing device 204 presents the selected offers to the purchaser 106. Next, at block 614, the transaction processing engine 226 receives a set of chosen offers chosen by the purchaser 106. In some embodiments, the interface presentation engine 210 detects the choices made by the purchaser 106, and transmits the set of chosen offers to the transaction processing engine 226 via the web interface engine 212. The method 600 then proceeds to a continuation terminal (“terminal A”).

From terminal A (FIG. 6B), the method 600 proceeds to block 616, where the transaction processing engine 226 stores a transaction record identifying the purchaser in a purchaser data store 222. Next, the method 600 proceeds to a for loop defined between a for loop start block 618 and a for loop end block 626. The for loop executes once for each offer in the set of chosen offers. From the for loop start block 618, the method 600 proceeds to block 620, where the transaction processing engine 226 adds the offer from the set of chosen offers to the transaction record, the offer optionally including a condition. As described above, the condition may include one or more actions to be taken by the purchaser 106. The condition may also include a time by which the action should be completed (such as within a predetermined duration after the offer is accepted, before a predetermined date, and/or the like), and/or a consequence of not completing the action (such as being excluded from other offers from the offer contributor 232, being excluded from the offer management system 202 altogether, being charged the amount provided in the offer, and/or the like).

Next, at block 622, the transaction processing engine 226 deducts an amount indicated in the offer from a contributor payment account 234 associated with the offer contributor 232, and at block 624, the transaction processing engine 226 adds the amount indicated in the offer to a purchase fulfillment account. In some embodiments, the purchase fulfillment account may be a separate payment account controlled by the offer management system 202. In some embodiments, the purchase fulfillment account may be associated with a one-time use account number associated with the contributor payment account 234.

The method 200 then proceeds to the for loop end block 626. If there are more offers in the set of chosen offers to be processed, the method 600 returns to the for loop start block 618 and repeats for the next offer in the set of chosen offers. If all of the offers in the set of chosen offers have been processed, the method 600 proceeds to block 628, where the offer management system 202 provides access to the purchase fulfillment account to a point-of-sale system 236 operated by the retailer 102. At block 630, the point-of-sale system 236 uses the purchase fulfillment account and a payment account of the purchaser 238 to complete the purchase transaction. In embodiments where the point-of-sale system 236 has been configured to interface directly with the offer management system 202, the transaction processing engine 226 may transmit an authorization to the point-of-sale system 236 to deduct the offer amount from the purchase fulfillment account. In embodiments where the point-of-sale system 236 has not been specially configured to interact with the offer management system 202, the point-of-sale system 236 may be provided with the one-time use account number (or other account access code) via a swipe card, via a scannable bar code presented by the purchaser computing device, via manual entry, and/or the like. The amount to be deducted from the purchase fulfillment account may be presented by the purchaser computing device 204 as a numerical value or as part of an encoded string or bar code to be entered into or scanned by the point-of-sale system 236. In some embodiments, the point-of-sale system 236 may be instructed to deduct the funds directly from contributor payment accounts 234 without using an intermediate purchase fulfillment account.

Once the point-of-sale system 236 receives the funds from the purchaser payment account 238 and the purchase fulfillment account, the purchase transaction is complete. In some embodiments, the method 600 proceeds to block 632, where a purchaser monitoring engine 228 determines whether the purchaser 106 has complied with the condition in the offer and takes appropriate action. In some embodiments, if the purchaser monitoring engine 228 determines that the purchaser has not complied with the condition, the purchaser monitoring engine 228 may cause the consequence defined in the offer to be executed. In some embodiments, the purchaser monitoring engine 228 may impose predetermined default sanctions against the purchaser if the offer does not define a particular consequence to be imposed. The method 600 then proceeds to an end block and terminates.

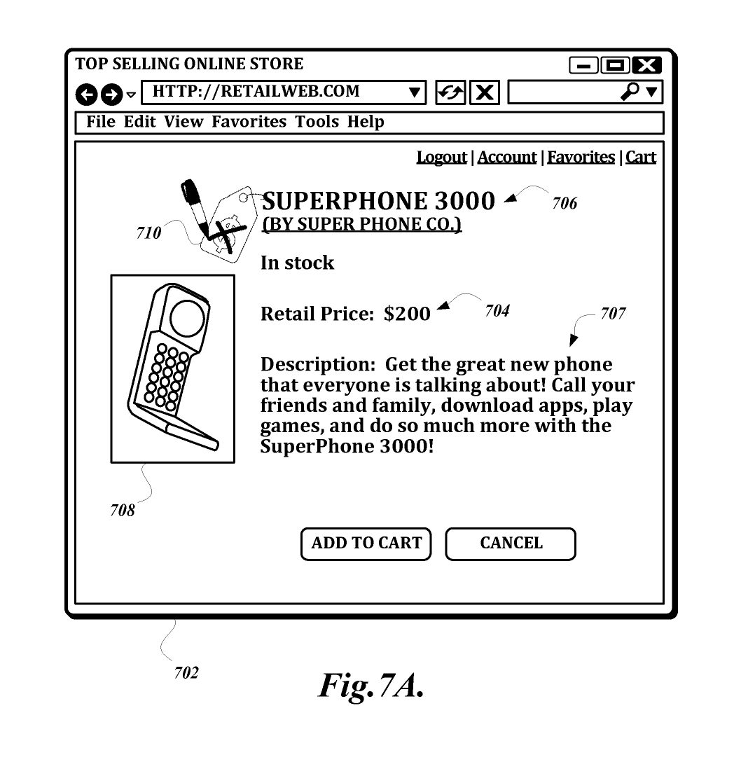

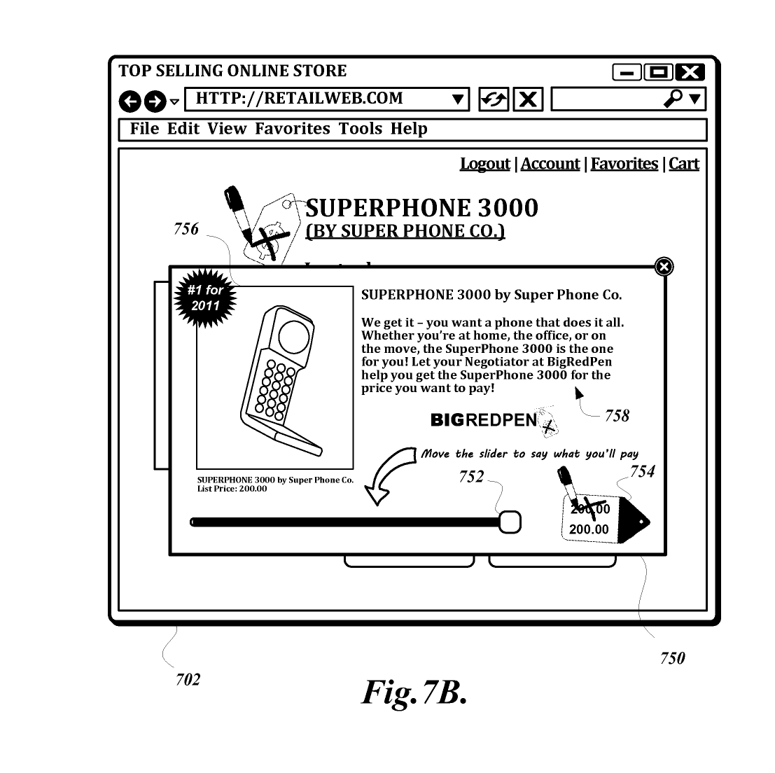

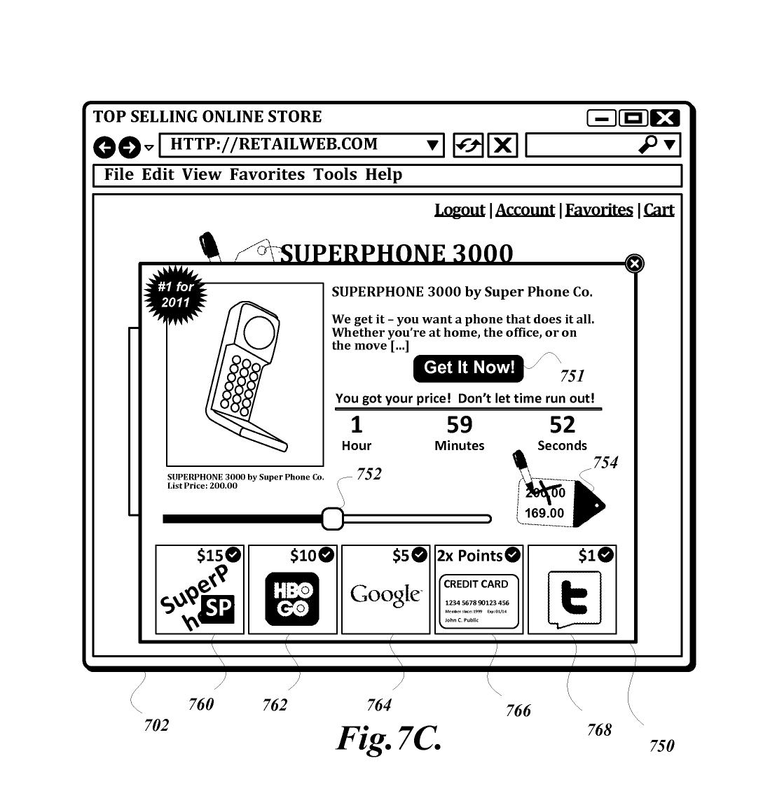

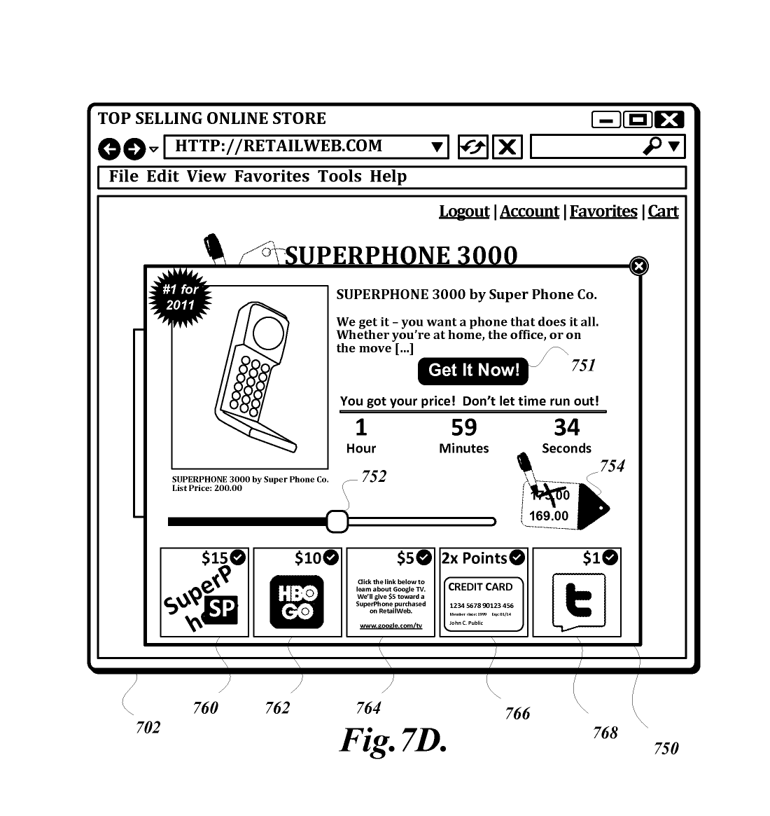

FIGS. 7A-7D are interface drawings that illustrate an exemplary embodiment of an interface presented by the interface presentation engine 210 according to various aspects of the present disclosure. As illustrated, the interface is depicted in relation to a web page displayed by a traditional web browser of a desktop computer. In some embodiments, a similar interface may be presented by a web browser on a mobile device such as a smart phone or tablet computer, by a custom application executing on a smart phone or other mobile device, by a kiosk, or by any other suitable computing device.

In FIG. 7A, a typical product page from a web-based retailer is shown. A name of the product 706 is shown, as is a description of the product 707 and an image depicting the product 708. A retail price 704 of the product is illustrated as $200. In the illustrated embodiment, the web browser may be enhanced with a plug-in or other extension provided by the offer management system 202. The web browser extension may be configured to identify a product name 706, a product description 707, a product image 708, and/or the like, regardless of the particular web retailer that is the source of the product page. Upon detecting such features in a displayed page, the web browser extension may display an offer retrieval interface element 710.

FIG. 7B illustrates an exemplary interface 750 presented upon interaction with the offer retrieval interface element 710 of FIG. 7A. As illustrated, the interface 750 presented to the purchaser 202 by the interface presentation engine 210 is a popup that is displayed over the product page 702 presented by the web retailer, but in other embodiments, the interface 750 may be presented as a separate web page, via a different communication channel such as email, and/or in any other suitable format. The interface 750 may include a product image 756, which may be obtained by the web browser extension from the document object model (DOM) of the underlying interface 702 presented by the web browser, such that the provider of the underlying interface 702 is not informed that the web browser extension is displaying the product image 756. The interface 750 may also include a product description 758 that includes information similarly obtained from the DOM of the underlying interface 702, or may be provided by the interface presentation engine 210. The interface 750 may also include a slider 752 and a price display 754. As illustrated in FIG. 7B, the slider 752 is set to a maximum value, and the price display 754 shows a retail price and an offer-adjusted price that is the same as the retail price (due to the lack of any offers). As discussed further below, the purchaser 202 may adjust the offer-adjusted price by manipulating the slider 752. Once a position for the slider 752 is selected by the purchaser 202, an offer search request is transmitted to the offer management system 202 as discussed above.

FIG. 7C illustrates the interface 750 once a position for the slider 752 has been selected by the purchaser 202 and a response to the offer search request has been received from the offer management system 202. A plurality of offers 760, 762, 764, 766, 768 are presented by the interface 750. The plurality of offers 760, 762, 764, 766, 768 collectively provide a discount that is equal to the amount by which the offer-adjusted price is reduced below the retail price, as shown in the price display 754. Several exemplary types of offers are included, such as a brand-associated offer 760 from the manufacturer of the phone, a bundle offer 762 from a manufacturer of a cross-promoted product, a cross-promotional offer 764 that may provide value for viewing a promotion for another product, and a social media offer 768 that may provide value for taking a particular action on a social network. A credit card offer 766 is also included, though it provides a value to the purchaser 202 other than a monetary value. Upon actuating an acceptance interface button 751, the values associated with each offer would be provided for the purchase transaction as discussed above, and the transaction with the retailer would continue towards fulfillment.

FIG. 7D illustrates a further aspect of the presented offers. Upon interacting with an offer such as offer 764, the presentation within the interface 750 changes from an identification of the offer and the value provided to a listing of one or more conditions under which the value is provided to the purchaser 202.

In some embodiments, the offer contribution amounts may not be displayed to the purchaser 202. In such an embodiment, more offers may be displayed by the interface 750 than necessary to reach the price indicated by the slider 752, and the difference in the total offer contribution amounts and the amount needed to reach the price indicated by the slider 752 may be returned to the offer contributors 232 or retained by the offer management system 202. In some embodiments, failing to accept one or more of the offers by clearing the “accept” checkbox associated with the offer may cause the slider 752 to move and the offer-adjusted price to change.

In some embodiments, the offer management system 202 may allow even greater flexibility in suggested offers than described above. For example, the offer management system 202 may be configured to compare the standard price for the product 104 with a price of the product 104 at other retailers using one or more product data providers 230. If the offer management system 202 finds a lower price for the product 104 at another retailer, the offer management system 202 may notify the purchaser 106. In some embodiments, the offer management system 202 may only display the identity of the other retailer and/or the price at the other retailer if the purchaser 106 accepts one or more offers associated with the present retailer. For example, the offer management system 202 may direct the purchaser 106 while present at a first retailer to purchase a popular phone at a second retailer for a lower price, as long as the purchaser 106 accepts an offer that includes purchasing a case for the phone at the first retailer as a condition. Such embodiments of the present disclosure may make it acceptable for retailers to allow cross promotion with competing retailers, as both retailers will likely consummate sales with the purchaser 106.

As will be appreciated by one skilled in the art, the specific routines described above in the flowcharts may represent one or more of any number of processing strategies such as event-driven, interrupt-driven, multi-tasking, multi-threading, and the like. As such, various acts or functions illustrated may be performed in the sequence illustrated, in parallel, or in some cases omitted. Likewise, the order of processing is not necessarily required to achieve the features and advantages, but is provided for ease of illustration and description. Although not explicitly illustrated, one or more of the illustrated acts or functions may be repeatedly performed depending on the particular strategy being used. Further, these FIGURES may graphically represent code to be programmed into a computer readable storage medium associated with a computing device.

While illustrative embodiments have been illustrated and described, it will be appreciated that various changes can be made therein without departing from the spirit and scope of the invention.

The embodiments of the invention in which an exclusive property or privilege is claimed are defined as follows:

1. An offer management system, comprising one or more computing devices configured to provide:
a transaction processing engine configured to:
query an offer data store for a set of offers based on an offer search request associated with a product and a purchaser;
receive, from the purchaser, a choice of one or more offers from the set of offers; and
for each chosen offer, cause an amount of funds indicated by the chosen offer to be transferred to a purchase fulfillment account.

2. The offer management system of claim 1, wherein the transaction processing engine is further configured to obtain a standard price for the product.

3. The offer management system of claim 2, wherein the offer search request is further associated with a proposed price, and wherein the transaction processing engine is further configured to select one or more offers from the set of offers based on at least the standard price and the proposed price.

4. The offer management system of claim 3, wherein each offer of the set of offers is associated with an amount of funds, and wherein the selected one or more offers from the set of offers are associated with an amount of funds that are together worth at least a difference between the proposed price and the standard price.

5. The offer management system of claim 1, wherein at least one chosen offer is associated with a condition, and wherein the one or more computing devices are further configured to provide a purchaser monitoring engine configured to monitor purchaser compliance with the condition.

6. The offer management system of claim 5, wherein the condition comprises one or more actions chosen from a group consisting of: performing a specified action on a social media platform; purchasing an additional specified product other than the product associated with the offer search request; and using a specified form of payment.

7. The offer management system of claim 1, wherein the one or more computing devices are further configured to provide a contributor interface engine configured to generate an interface that enables one or more offer contributors to manage offers.

8. The offer management system of claim 7, wherein the contributor interface engine is further configured to generate an interface that enables one or more product manufacturers to control types of offers that are returned in response to offer search requests associated with products of the one or more product manufacturers.

9. The offer management system of claim 1, wherein querying an offer data store for a set of offers based on an offer search request associated with a product and a purchaser comprises:
querying an offer data store for a set of offers based on attributes of the purchaser, wherein the attributes of the purchaser include one or more of a brand affinity of the purchaser, a purchase history of the purchaser, and demographic information associated with the purchaser.

10. The offer management system of claim 1, wherein querying an offer data store for a set of offers based on an offer search request associated with a product and a purchaser comprises:
querying an offer data store for a set of offers based on exclusions associated with the product.

11. The offer management system of claim 1, wherein the transaction processing engine is further configured to present the set of offers to the purchaser for choosing one or more offers from the set of offers.

12. The offer management system of claim 1, wherein causing an amount of funds indicated by the chosen offer to be transferred to a purchase fulfillment account comprises causing an amount of funds indicated by the chosen offer to be transferred from a contributor payment account of an offer contributor associated with the chosen offer.

13. A computer-implemented method of configuring a computing device to interact with a server, the method comprising:
receiving, by a computing device, contact information associated with a purchaser;
modifying, by the computing device, the contact information to include a relationship referencing contact information associated with the server; and
transmitting the modified contact information to a purchaser computing device.

14. The computer-implemented method of claim 13, wherein the method further comprises transmitting, by the computing device, server contact information associated with the server to the purchaser computing device.

15. The computer-implemented method of claim 14, wherein the server contact information includes one or more of an email address, an SMS gateway address, and a URL.

16. A computer-implemented method of communicating with a server using a computing device, the method comprising:
storing, by the computing device in a contact data store, server contact information associated with the server;
transmitting, by the computing device, purchaser contact information associated with a purchaser to the server;
receiving, by the computing device, modified purchaser contact information; and
storing, by the computing device, the modified purchaser contact information in the contact data store.

17. The computer-implemented method of claim 16, wherein the modified purchaser contact information includes a relationship associating the modified purchaser contact information with the server contact information.

18. The computer-implemented method of claim 17, further comprising:
parsing a command received by the computing device to determine a destination and a query;
determining that the destination is the server based on at least the relationship associating the modified purchaser contact information with the server contact information; and
transmitting the query to the server using at least a portion of the server contact information.

19. The computer-implemented method of claim 18, wherein the command is received by the computing device via a text-to-speech engine.

20. The computer-implemented method of claim 18, wherein the query is transmitted to the server via an SMS gateway engine.
